(19) United States
(12) Patent Application Publication
(10) Pub. No.: US 2020/0344990 A1
(43) Pub. Date: Nov. 5, 2020

(54) Dissolvable Fishing Weight

(71) Applicant: Travis Hansen, Brigham, UT (US)

(72) Inventor: Travis Hansen, Brigham, UT (US)

(21) Appl. No.: 16/401,255

(22) Filed: May 2, 2019

(51) Int. Cl. A01K 95/00

(52) U.S. Cl. CPC A01K 95/005

(57) ABSTRACT

A dissolvable fishing weight for assisting in casting fishing line and then detaching from the line in an eco-friendly manner includes a shell body having an outside surface and an inside surface. The inside surface forms an inner cavity. An eyelet is coupled to the outside surface of the shell body and has an eyelet aperture extending therethrough. The eyelet is configured to receive a fishing line through the eyelet aperture. A fill is coupled within the inner cavity. The shell body and the eyelet are water soluble and configured to dissolve once the fishing line has been cast into the water to release the fishing line and the fill.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fishing weights and more particularly pertains to a new fishing weight assisting in casting fishing line and then detaching from the line in an eco-friendly manner.

### BRIEF SUMMARY OF THE INVENTION

An embodiment of the disclosure meets the needs presented above by generally comprising a shell body having an outside surface and an inside surface. The inside surface forms an inner cavity. An eyelet is coupled to the outside surface of the shell body and has an eyelet aperture extending therethrough. The eyelet is configured to receive a fishing line through the eyelet aperture. A fill is coupled within the inner cavity. The shell body and the eyelet are water soluble and configured to dissolve once the fishing line has been cast into the water to release the fishing line and the fill.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a dissolvable fishing weight according to an embodiment of the disclosure.

FIG. 2 is a front elevation view of an embodiment of the disclosure.

FIG. 3 is a cross-sectional view of an embodiment of the disclosure.

### DETAILED DESCRIPTION OF THE INVENTION

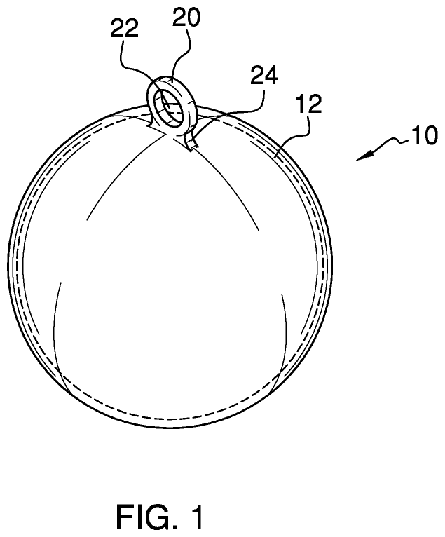

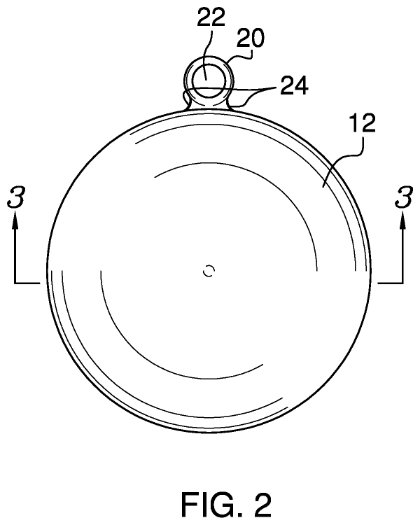

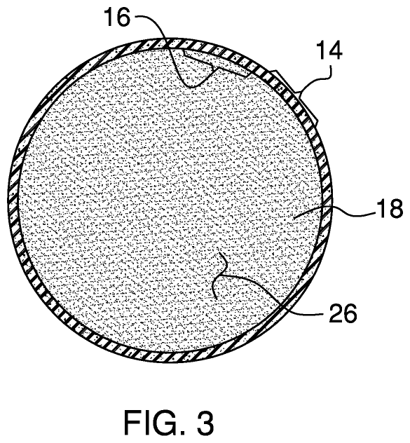

With reference now to the drawings, and in particular to FIGS. 1 through 3 thereof, a new fishing weight embodying the principles and concepts of an embodiment of the disclosure and generally designated by the reference numeral 10 will be described.

As best illustrated in FIGS. 1 through 3, the dissolvable fishing weight 10 generally comprises a shell body 12. The shell body 12 is either spherical or ellipsoidal and has an outside surface 14 and an inside surface 16. The inside surface 16 forms an inner cavity 18. The shell body 12 may have a uniform thickness making the inner cavity 18 a proportional sphere or ellipsoid.

An eyelet 20 is coupled to the shell body 12. The eyelet 20 is annular and coupled to the outside surface 14. The eyelet 20 has an eyelet aperture 22 extending therethrough. The eyelet 20 may have a pair of joining fillets 24 extending to be between 60° and 120° apart on the eyelet 20 with a perimeter of each of the joining fillets 24 being between 30° and 90°. The pair of joining fillets 24 provide increased contact area and more structural integrity. The eyelet 20 is configured to receive a fishing line through the eyelet aperture 22. The eyelet 20 lies in a plane perpendicular to a tangent plane of the outer surface 14 to facilitate feeding of the fishing line through the eyelet aperture 22.

A fill 26 is coupled to the shell body 12 within the inner cavity 18. The fill 26 is granular and may entirely occupy the inner cavity in order to maximize density of the weight 10. The shell body 12 and the eyelet 20 are gelatinous and water soluble and are configured. The fill 26 is either a natural or a biodegradable material. The fill 26 may be natural sand.

In use, the fishing line is threaded through the eyelet aperture 22 and tied to secure the weight 10. The fishing line is also attached to a float lure or other baiting configuration that is designed to float at the surface of the water. The weight 10 provides added casting distance, but once cast into the water the eyelet 20 and the shell body 12 dissolve, releasing the fishing line and the fill 26. The float lure may then perform as intended and the natural or biodegradable fill 26 enters the water in a harmless and environmentally conscious manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dissolvable fishing weight comprising:
a shell body, the shell body having an outside surface and an inside surface, the inside surface forming an inner cavity;
an eyelet coupled to the shell body, the eyelet being coupled to the outside surface, the eyelet having an eyelet aperture extending therethrough, the eyelet being configured to receive a fishing line through the eyelet aperture; and
a fill coupled to the shell body, the fill being coupled within the inner cavity;
wherein the shell body and the eyelet are water soluble and configured to dissolve once the fishing line has been cast into the water to release the fishing line and the fill.

2. The dissolvable fishing weight of claim 1 further comprising the shell body being either spherical or ellipsoidal.

3. The dissolvable fishing weight of claim 1 further comprising the eyelet being annular.

4. The dissolvable fishing weight of claim 3 further comprising the eyelet having a pair of joining fillets.

5. The dissolvable fishing weight of claim 4 further comprising the joining fillets extending to be between 60° and 120° apart.

6. The dissolvable fishing weight of claim 5 further comprising a perimeter of each of the joining fillets being between 30° and 90°.

7. The dissolvable fishing weight of claim 1 further comprising the fill being granular.

8. The dissolvable fishing weight of claim 7 further comprising the feel being either a natural material or a biodegradable material.

9. The dissolvable fishing weight of claim 7 further comprising the fill being sand.

10. The dissolvable fishing weight of claim 1 further comprising the shell body and the eyelet being gelatinous.

11. A dissolvable fishing weight comprising:
a shell body, the shell body being either spherical or ellipsoidal and having an outside surface and an inside surface, the inside surface forming an inner cavity;
an eyelet coupled to the shell body, the eyelet being annular and coupled to the outside surface, the eyelet having an eyelet aperture extending therethrough, the eyelet having a pair of joining fillets extending to be between 60° and 120° apart, a perimeter of each of the joining fillets being between 30° and 90°, the eyelet being configured to receive a fishing line through the eyelet aperture; and
a fill coupled to the shell body, the fill being coupled within the inner cavity, the fill being granular, natural sand;
wherein the shell body and the eyelet are gelatinous and water soluble and configured to dissolve once the fishing line has been cast into the water to release the fishing line and the fill.
